(19) United States
(12) Patent Application Publication
(10) Pub. No.: US 2014/0070058 A1
(43) Pub. Date: Mar. 13, 2014

(54) METAL FOAMS FOR CIRCUMFERENTIAL SUPPORT IN HIGH TEMPERATURE/VIBRATION APPLICATIONS

(71) Applicants: Bradley James MILLER, Simpsonville, SC (US); Donald Earl FLOYD, II, Greenville, SC (US)

(72) Inventors: Bradley James MILLER, Simpsonville, SC (US); Donald Earl FLOYD, II, Greenville, SC (US)

(73) Assignee: GENERAL ELECTRIC COMPANY, Schenectady, NY (US)

(21) Appl. No.: 13/608,343

(22) Filed: Sep. 10, 2012

(51) Int. Cl. F16L 3/10; B23P 11/00

(52) U.S. Cl. 248/65; 29/428

(57) ABSTRACT

A tube holder for use in turbomachinery includes a housing having a passage for receiving a tube, the housing adapted for attachment to a turbomachinery component; and a metal foam component located within the housing and arranged to engage a length portion of the tube to thereby hold the tube within the housing and reduce undesirable vibrations in the tube during operation of the turbomachinery.

### BACKGROUND OF THE INVENTION

This invention relates to gas turbine technology generally, and more specifically, to a method and system for protecting sensitive instrumentation subject to thermal stress vibration and stress concentrators in, for example, an exhaust gas duct of the gas turbine.

In certain gas turbine applications, a tubing system is housed in an exhaust duct of a gas turbine and is used to contain one or more sensors, for example, thermal Bragg sensors. During testing, however, the flexible tube and/or sensors have been known to fail due to a combination of thermal stress, vibration and stress concentrators introduced by the support mechanisms used to hold and/or clamp the sensor tube to an array of circumferentially-spaced holders (or tube supports).

Various clamping schemes have been tried with only limited success. In addition, more exotic sensor holding materials have been tested but the materials of choice can have a significant negative impact on cost. Accordingly, there remains a need for a relatively simple and inexpensive mechanism by which the sensor tube and the sensors within the tube can be better protected in the harsh thermal environment of a gas turbine exhaust duct.

### BRIEF SUMMARY OF THE INVENTION

In accordance with an exemplary but nonlimiting embodiment, there is provided a tube holder for use in turbomachinery comprising a housing having a passage for receiving a tube, said housing adapted for attachment to a turbomachine component; and a metal foam component located within the housing and shaped and arranged to engage and hold a length portion of the tube within the housing.

In another aspect, there is provided a tube holder for a sensor tube adapted to be supported within a duct of a turbine engine, the tube holder comprising a housing adapted for mounting on a support post extending into the duct; the housing having a passage for receiving the sensor tube; and a metal foam component located within the housing and arranged to engage a length portion of the sensor tube.

In still another aspect, the invention provides a method of supporting a flexible sensor tube in a tube holder comprising providing a housing formed with a passage therethrough; and locating a metal foam sleeve within the passage and supporting the sensor tube within the metal foam sleeve.

The invention will now be described in greater detail in conjunction with the drawings identified below.

### BRIEF DESCRIPTION OF THE DRAWINGS

FIG. 1 is a simplified partial end elevation showing a sensor tube supported within a duct by a plurality of supports;

FIG. 2 is an enlarged detail of an installation as shown in FIG. 1;

FIG. 3 is a side elevation, partly in section, showing a tube holder for use in a support as shown in FIGS. 1 and 2 in accordance with a first exemplary but nonlimiting embodiment;

FIG. 4 is a side elevation, partly in section, showing another tube holder for use in a support as shown in FIGS. 1 and 2 in accordance with another exemplary but nonlimiting embodiment; and

FIG. 5 is a perspective view, partly in section, of a third tube holder for use in a support as shown in FIGS. 1 and 2 accordance with still another exemplary but nonlimiting embodiment.

### DETAILED DESCRIPTION OF THE INVENTION

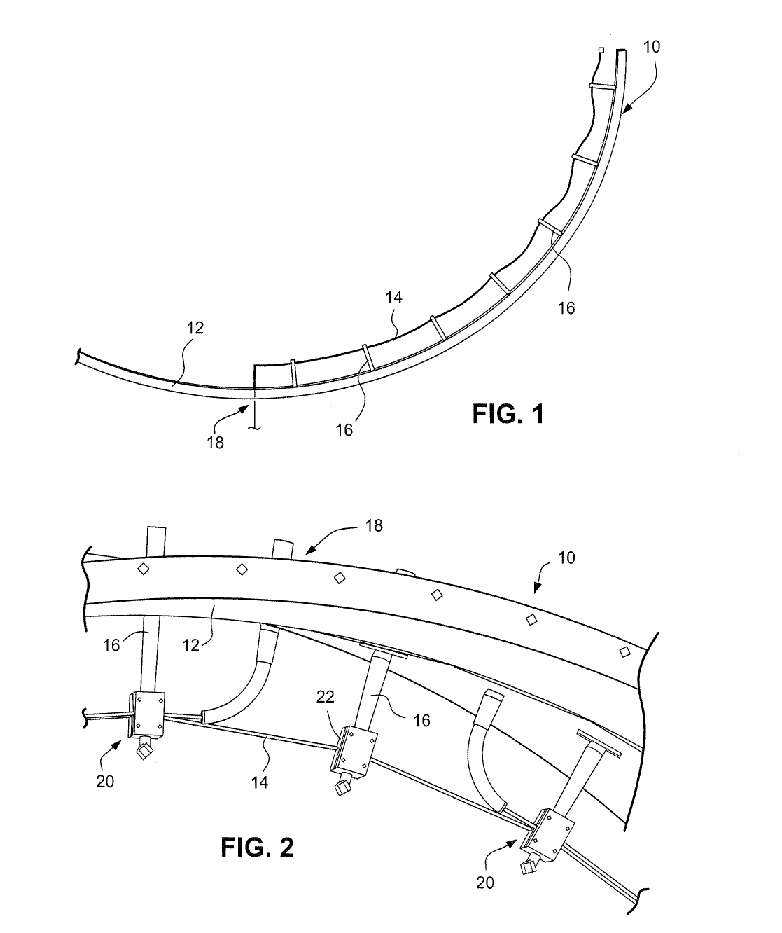

FIGS. 1 and 2 partially illustrate in simplified form a cylindrical duct or housing 10 which may be, in the illustrated example, a turbine exhaust duct. The duct 10 is comprised of an annular wall 12, only partially shown. A flexible sensor tube 14 extends about the duct wall 12, supported by radially inwardly directed posts or tubing supports 16. The sensor tube 14 encloses and supports one or more sensors (for example, thermal Bragg sensors, not shown) that may be spaced circumferentially about the duct wall. As shown in FIG. 1, the flexible tube enters the duct wall at 18 and may exit the duct wall at a location proximate the entry location. As shown on the right-hand side of the FIG. 1, the flexible tube 14 may sag between posts 16 due to differential thermal growth, high stresses and other factors. Typically, the tube 14 is clamped to the posts 16 by various known tube holders or supports 20 as best seen In FIG. 2. It has been observed that where the tube is tightly clamped within the holder 20, the sagging of the tube tends to produce crimps in the tube where it enters and exits the holder, giving rise to stress concentrators leading to eventual failure of the tube.

In other prior arrangements, the tube passes through a tube holder or support (similar to the device 20) on the support post 16, but without an internal clamping mechanism, so as to enable the tube to slide relative to the holder and thus avoid sagging and bending stresses. On the other hand, the non-clamped arrangement promotes undesirable vibrations in the tube, possibly leading to fatigue cycle failures.

FIG. 3 illustrates a first exemplary but nonlimiting embodiment of a tube clamp that may be mounted within an axial passage through the holder 20 that does not result in crimping of the tube 14, and that allows some limited sliding movement but without vibrations attendant the known, non-clamped tube holders.

More specifically, the opening in the end plate or wall 22 (see FIG. 2) of a tube holder 20 is fitted with a nut body 24 by any suitable fastening arrangement. The nut body includes a projecting, exteriorly threaded inner nut component 26 formed with a tapered or conical inside wall 28. An open-ended metal foam ferrule or sleeve 30 has a smooth interior diameter defined by wall 32, and a conical exterior wall 34 adapted to mate with the inside wall 28 of the nut component 26. An internally threaded outer nut component (or lock nut) 36 is threaded onto the inner nut component 26, such that an end face 38 urges the ferrule 30 axially into the nut component 26, thereby wedging the metal foam ferrule 30 against a length portion of the tube 14. The nut component is formed with a center aperture 40 permitting passage of the tube. It will be understood that the lock nut 36 will be tightened to the prescribed torque that results in optimum clamping of the tube 14 but allows some limited axial movement. The tube 14 is fully engaged by the ferrule 30, however, thereby reducing if not eliminating any undesired vibration of the tube 14 within the holder 20. It will be appreciated that the clamping device described above is not limited to use with the illustrated holders 20, but may be used in other holder designs as well.

The metal foam ferrule 30 may be formed from any of a variety of high temperature alloys typically used in gas turbine applications, e.g. iron-chrome alloys (e.g. FeCrAlY), nickel-iron alloys (e.g., Inconel), aluminum alloys (for low temperature applications), etc. The density of the foam will be chosen so as to provide the required holding power without, however, also resulting in crimping of the tube. The metal foam ferrule may be of one- or two-piece construction.

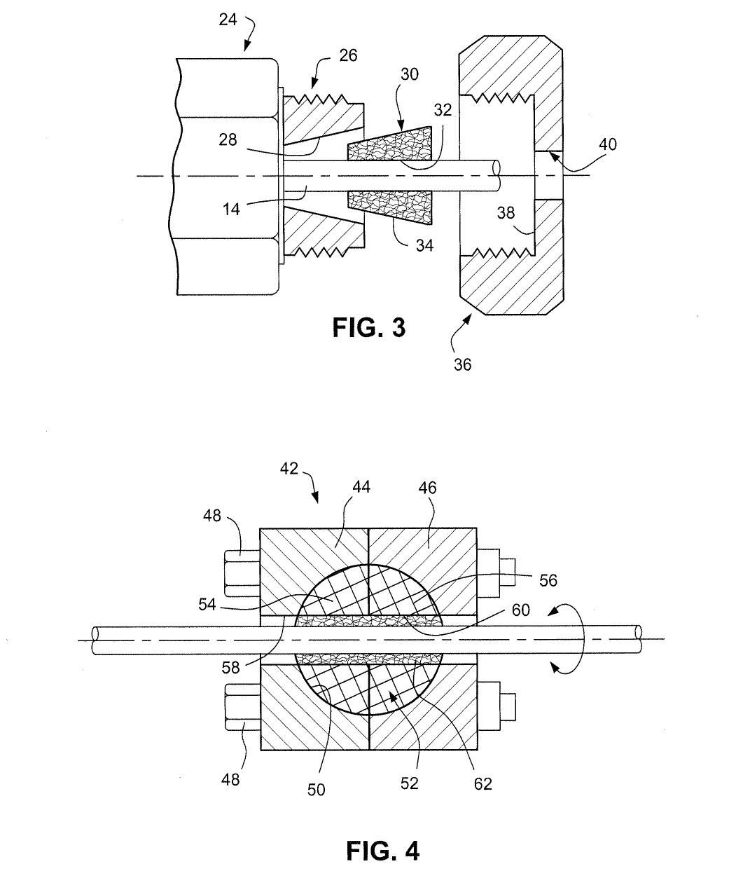

FIG. 4 illustrates another exemplary but nonlimiting embodiment where a tubing holder 42 is composed of two substantially identical housing portions 44, 46 joined together by, for example, bolts 48 and formed so as to provide a center cavity 50 of spherical shape. A metal sphere 52, comprised of hemispheres 54, 56 is seated with in the cavity 50, with center bores 58, 60 axially aligned to provide a through passage for the tube 14. The bores 58, 60 have diameters sufficiently large to accommodate a metal foam sleeve 62 that fits over the tube 14. Tightening of the bolts 48 applies a light clamping force on the tube 14 through the foam sleeve 62. Note that the space surrounding the tubing 14 at either end of the housing (beyond the edges of the sleeve 62) will allow for some relative angular movement between the tube and the housing portions 44, 46 without wearing on the tube. In addition, the sphere 52 is permitted some limited degree of rotation within the cavity 50, again permitting movement of the tube without damaging the tube and without affecting the clamping of the tube via the foam sleeve 62.

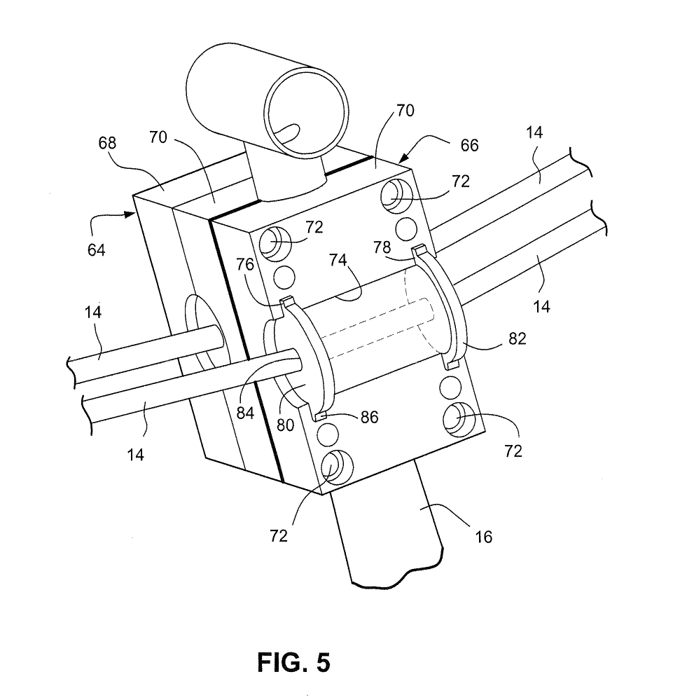

FIG. 5 illustrates another exemplary but nonlimiting embodiment of a tube holder. In this variant, back-to-back tube holders 64, 66 are mounted on the post 16 so as to support a pair of adjacent sensor tubes 14. Each holder is composed of split housing sections 68, 70, noting that the housing section 68 for the holder 66 has been removed to facilitate an understanding of the construction. The holders 64, 66 may be fastened together by bolts (not shown) passing through aligned sets of bolt holes 72. A generally semi-cylindrical cavity 74 is formed in each housing section, with larger-diameter annular grooves 76, 78 formed at opposite ends of the cavity. These grooves receive oversized tube guides or disks 80, 82 with center apertures (one shown at 84) that receive the tube. The disks 80, 82 may be formed with tabs or keys 86 that fit into notches formed in the grooves 76, 78 to lock the disks against rotation when secured between the housing sections.

Between the tube guides or disks 80, 82, the cavity 74 is filled with a metal foam sleeve 88 having a metal foam composition as described above. The foam sleeve 88 encloses and engages the tube 14, but the tube is able to slide axially relative to the sleeve and the holder 66. This arrangement provides support while preventing vibration “chatter” and thus wear on the tube. Note that clamping forces generated by the assembly of housing sections 68, 70 are absorbed by the disks 80, 82, insuring that the sleeve 88 is not subject to excessive clamping forces.

In each of the described embodiments, the metal foam sleeve is used to either clamp the sensor tube without damage to the tube, and/or to support the sensor tube in a manner that prevents unwanted vibrations.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A tube holder for use in turbomachinery comprising:
a housing having a passage for receiving a tube, said housing adapted for attachment to a turbomachine component; and
a metal foam component located within the housing and shaped and arranged to engage and hold a length portion of the tube within the housing.

2. The tube holder of claim 1 wherein said metal foam component comprises an open-ended sleeve.

3. The tube holder of claim 2 wherein said open-ended sleeve is comprised of two halves which combined to form substantially truncated-cone shape, with an axial center passage and a tapered peripheral wall.

4. The tube holder of claim 3 wherein said housing includes a threaded portion having an interior surface adapted to mate with said tapered peripheral wall.

5. The tube holder of claim 4 and further comprising a lock nut adapted to threadably engage said threaded portion, said lock nut provided with an end face adapted to exert an axial wedging force on said sleeve, thereby causing said sleeve to clamp the tube.

6. The tube holder of claim 2 wherein said sleeve is seated within a spherical component supported within said housing.

7. The tube holder of claim 6 wherein said spherical component is comprised of two hemispherical sections joined along an axial center passage that receives said sleeve, and further wherein said sleeve is sized to permit the tube to slide relative to the sleeve alloy.

8. The tube holder of claim 1 wherein said metal foam is comprised of a high-temperature alloy.

9. The tube holder of claim 2 wherein said sleeve is supported in split sections of said housing, said sleeve engaged between a pair of disks supported at opposite ends of said housing, said disks having diameters larger than a diameter of said sleeve.

10. A tube holder for a sensor tube adapted to be supported within a duct of a turbine engine, the tube holder comprising a housing adapted for mounting on a support post extending into the duct; said housing having a passage for receiving the sensor tube; and
a metal foam component located within the housing and arranged to engage a length portion of said sensor tube.

11. The tube holder of claim 10 wherein said metal foam component comprises a sleeve that encloses the length portion of said sensor tube.

12. The tube holder of claim 11 wherein said sleeve has a substantially truncated-cone shape with an axial center passage and a tapered peripheral wall.

13. The tube holder of claim 12 wherein said housing includes a threaded portion having an interior surface adapted to mate with said tapered peripheral wall.

14. The tube holder of claim 13 and further comprising a lock nut adapted to threadably engage said threaded portion, said lock nut provided with an end face adapted to exert an axial force on said sleeve, thereby causing said sleeve to clamp the tube.

15. The tube holder of claim 11 wherein said sleeve is seated within a spherical component supported within said housing.

16. The tube holder of claim 15 wherein said spherical component is comprised of two hemispherical sections joined along an axial center passage that receives said sleeve.

17. The tube holder of claim 10 wherein said metal foam comprises a high-temperature alloy.

18. The tube holder of claim 11 wherein said sleeve is supported in split halves of said housing, said sleeve engaged between a pair of disks supported at opposite ends of said housing, said disks having diameters larger than a diameter of said sleeve.

19. A method of supporting a flexible sensor tube in a tube holder comprising:
a) providing a housing formed with a passage therethrough; and
b) locating a metal foam sleeve within said passage and supporting the sensor tube within said foam metal sleeve.

20. The method of claim 19 including applying compression to said metal foam sleeve to thereby clamp said sensor tube within said housing.
